(19) United States
(12) Patent Application Publication
(10) Pub. No.: US 2026/0246692 A1
(43) Pub. Date: Aug. 20, 2026

(54) PARAMETER CONFIGURATION METHOD AND APPARATUS, AND COMPUTER DEVICE

(71) Applicant: ZHEJIANG LAB, Hangzhou, Zhejiang (CN)

(72) Inventors: Xuyang Zhao, Hangzhou, Zhejiang (CN); Fujun Zhang, Hangzhou, Zhejiang (CN)

(21) Appl. No.: 19/162,414

(22) PCT Filed: Jul. 11, 2025
(86) PCT No.: PCT/CN2025/108024

§ 371 Date: Sep. 5, 2025

(30) Foreign Application Priority Data
Feb. 19, 2025 (CN) 202510185725.0

(51) Int. Cl. H04L 41/0803

(52) U.S. Cl. CPC H04L 41/0803

(57) ABSTRACT

Provided are a parameter configuration method and apparatus, and computer device. The method includes: displaying content of a constraint file model corresponding to a target network device, where the content includes a first configuration parameter corresponding to a current running state of the target network device; in response to a configuration parameter modification operation, modifying the first configuration parameter to a second configuration parameter, where in a process of modifying the first configuration parameter to the second configuration parameter, the target network device continues maintaining the current running state with the first configuration parameter; and sending the second configuration parameter to the target network device, such that the target network device still maintains the current running state with the first configuration parameter after receiving the second configuration parameter, and at next startup, the target network device can start to enter a running state corresponding to the second configuration parameter.

### TECHNICAL FIELD

The present disclosure relates to the technical field of network communications, and in particular, to a parameter configuration method and apparatus, and a computer device.

### BACKGROUND

With the large-scale development of cluster networks and the vertical application of various big data industries, higher requirements are imposed on real-time performance, compatibility, stability, and reliability of network data transmission. However, related technologies still fall short in terms of reliability, real-time performance, and stability of data transmission. Therefore, a new parameter configuration method is required for the cluster networks.

### SUMMARY

The present disclosure is intended to at least solve one of technical problems in related technologies to some extent. Therefore, the present disclosure provides a parameter configuration method, a parameter configuration apparatus, and a computer device. The present disclosure mainly adopts the following technical solutions:

According to a first aspect, the embodiments of the present disclosure provide a parameter configuration method, applied to a configuration server, where the configuration server is communicatively connected to a target network device, and the parameter configuration method includes: displaying content of a constraint file model corresponding to the target network device, where the content of the constraint file model includes a first configuration parameter corresponding to a current running state of the target network device; in response to a configuration parameter modification operation, modifying the first configuration parameter to a second configuration parameter suitable for the target network device, where in a process of modifying the first configuration parameter to the second configuration parameter, the target network device continues maintaining the current running state with the first configuration parameter; and sending the second configuration parameter in a format of the constraint file model to the target network device, such that the target network device still maintains the current running state with the first configuration parameter after receiving the second configuration parameter; and at next startup, by the target network device, starting based on the second configuration parameter to enter a running state corresponding to the second configuration parameter.

Optionally, the configuration server is communicatively connected to a plurality of network devices, and before the displaying content of a constraint file model corresponding to the target network device, the parameter configuration method further includes: in response to a network device selection operation, determining the target network device whose configuration parameter needs to be modified from the plurality of network devices; and establishing a network management protocol session between the configuration server and the target network device.

Optionally, the first configuration parameter is stored in a configuration information base (CIB) of the target network device in the format of the constraint file model, and before the displaying content of a constraint file model corresponding to the target network device, the parameter configuration method further includes: sending a parameter locking instruction to the target network device, where the parameter locking instruction is configured to instruct the target network device to lock the CIB and continue maintaining the current running state with the first configuration parameter.

Optionally, the CIB includes a primary configuration database, a backup configuration database, and a startup configuration database, and the parameter locking instruction is configured to instruct the target network device to lock the primary configuration database or simultaneously lock the primary configuration database, the backup configuration database, and the startup configuration database; the primary configuration database is configured to store a configuration parameter corresponding to the current running state of the target network device; the backup configuration database is configured to store backup data of the configuration parameter corresponding to the current running state of the target network device; and the startup configuration database is configured to store a recovery configuration parameter used by the target network device after restarting.

Optionally, the sending the second configuration parameter in a format of the constraint file model to the target network device specifically includes: sending the second configuration parameter in the format of the constraint file model to the target network device, such that the target network device modifies the first configuration parameter to the second configuration parameter; and sending a parameter unlocking instruction to the target network device, where the parameter unlocking instruction is configured to release a locked state of the CIB.

Optionally, after the sending the second configuration parameter in a format of the constraint file model to the target network device, the parameter configuration method further includes: after the second configuration parameter in the format of the constraint file model passes compliance verification of the target network device, receiving a confirmation response sent by the target network device.

Optionally, the first configuration parameter is stored in a primary configuration database of the target network device in the format of the constraint file model, and after receiving the confirmation response, the parameter configuration method further includes: sending a parameter modification instruction to the target network device, such that the target network device modifies the first configuration parameter in the primary configuration database to the second configuration parameter, and in a process of modifying the first configuration parameter by the target network device, the target network device still maintains the current running state with the first configuration parameter.

Optionally, the first configuration parameter includes one or more of a quality of service (QoS) configuration parameter, a port list configuration parameter, and a traffic management configuration parameter; and the traffic management configuration parameter includes one or more of traffic shaping, bandwidth allocation, and a bandwidth priority policy.

According to a second aspect, the embodiments of the present disclosure provide a parameter configuration apparatus, applied to a configuration server, where the configuration server is communicatively connected to a target network device, and the parameter configuration apparatus includes: a configuration parameter displaying module configured to display content of a constraint file model corresponding to the target network device, where the content of the constraint file model includes a first configuration parameter corresponding to a current running state of the target network device; a configuration parameter modification module configured to: in response to a configuration parameter modification operation, modify the first configuration parameter to a second configuration parameter suitable for the target network device, where in a process of modifying the first configuration parameter to the second configuration parameter, the target network device continues maintaining the current running state with the first configuration parameter; and a configuration parameter running module configured to send the second configuration parameter in a format of the constraint file model to the target network device, such that the target network device still maintains the current running state with the first configuration parameter after receiving the second configuration parameter; and at next startup, by the target network device, start based on the second configuration parameter to enter a running state corresponding to the second configuration parameter.

According to a third aspect, the present disclosure further provides a computer device, including a memory and a processor, where the memory stores a computer program, and the processor executes the computer program to implement the steps of the parameter configuration method according to any one of the above embodiments.

According to a fourth aspect, the present disclosure further provides a computer-readable storage medium. The computer-readable storage medium stores a computer program, and the computer program is executed by a processor to implement the steps of the parameter configuration method according to any one of the above embodiments.

According to a fifth aspect, the present disclosure provides a computer program product, including a computer program, where the computer program is executed by a processor to implement the steps of the parameter configuration method according to any one of the above embodiments.

In the above embodiments, the content of the constraint file model corresponding to the target network device is displayed, which allows a user to dynamically adjust a configuration parameter in a custom manner based on an actual running state and requirement of a network device, thereby providing the user with high flexibility to adapt to different network environments and business needs. In addition, in the process of modifying the first configuration parameter to the second configuration parameter, it is ensured that the target network device can continue maintaining the current running state with the first configuration parameter. In this way, the network device does not need to interrupt a service in a configuration updating process, thereby ensuring continuity and real-time performance of a network. Thus, a real-time configuration method that can flexibly and dynamically adjust a parameter of the network device as required without interrupting the service is achieved.

### BRIEF DESCRIPTION OF THE DRAWINGS

To describe the technical solutions in the specific implementations of the present disclosure or the prior art more clearly, the accompanying drawings required for describing the specific implementations or the prior art are briefly described below. Apparently, the accompanying drawings in the following description show merely some implementations of the present disclosure, and those of ordinary skill in the art may still derive other accompanying drawings from these accompanying drawings without creative efforts.

FIG. 1a is a flowchart of a parameter configuration method according to an embodiment of the present disclosure;

FIG. 1b is a schematic diagram of device networking in a cluster network according to an embodiment of the present disclosure;

FIG. 2 is a flowchart of a method for determining a target network device according to another embodiment of the present disclosure;

FIG. 3 is a structural block diagram of a parameter configuration apparatus according to still another embodiment of the present disclosure; and

FIG. 4 is an internal structural diagram of a computer device according to an embodiment of the present disclosure.

### DETAILED DESCRIPTION

In order to make the objectives, technical solutions, and advantages of the embodiments of the present disclosure clearer, the technical solutions in the embodiments of the present disclosure are clearly and completely described below with reference to the accompanying drawings in the embodiments of the present disclosure. Apparently, the described embodiments are some rather than all of the embodiments of the present disclosure. All other embodiments obtained by those skilled in the art based on the embodiments of present disclosure without creative efforts fall within the protection scope of present disclosure.

With the advancement of new-generation information network technologies and the integration of massive data generated by the Internet of Everything, data management planning has become more rational, meeting data transmission requirements of different application scenarios. Distributed parallel computing is a key means of training a large artificial intelligence (AI) model, typically including various parallel computing modes such as data parallelism, pipeline parallelism, and tensor parallelism. All parallel modes require a plurality of collective communication operations among a plurality of computing devices. To meet demands for scale construction of a future intelligent computing center and development and deployment of the large AI model, a new type of intelligent computing center network characterized by no blocking, a high bandwidth, and an ultra-low latency is developed to effectively facilitate rapid growth of high-performance businesses such as AI generated content (AIGC).

However, a data center in related technologies often adopts a solidified network architecture, which exhibits drawbacks in reliability, real-time performance, and stability of data transmission. A command-line interface (CLI) configuration method adopted by switching and routing devices in the data center has a problem of configuration command incompatibility, imposes a high requirement on professional knowledge of an engineer, incurs a high manual maintenance cost, and demonstrates a high error rate in a configuration process, ultimately failing to effectively adapt to a development trend of contemporary network technologies.

Specifically, a session protocol used in the related technologies specifies a message structure, and an architecture that is read and parsed by byte steam. In order to better express a richer message structure in a byte stream, type-length-value (TLV) and other methods are used to define an object. However, scalability of these methods is limited, for example, if an object is expanded or modified, code needs to be changed. Moreover, a byte stream-based session protocol used in the related technologies can be regarded as a program with an explicitly defined execution flow. Therefore, a data model can be analogized to a programming language for writing the program. If a protocol is extended with a large amount of private data, firstly, the protocol has a serious compatibility problem. Secondly, code in a protocol stack of the protocol is almost completely rewritten, which is time-consuming and labor-intensive.

Based on this, according to the embodiments of the present disclosure, an embodiment of a parameter configuration method is provided. It should be noted that, steps illustrated in the flowchart in the accompanying drawings may be executed in a computer system, such as a set of computer-executable instructions. Moreover, although a logic sequence is illustrated in the flowchart, in some cases, the illustrated or described steps may be executed in a sequence different from that described herein.

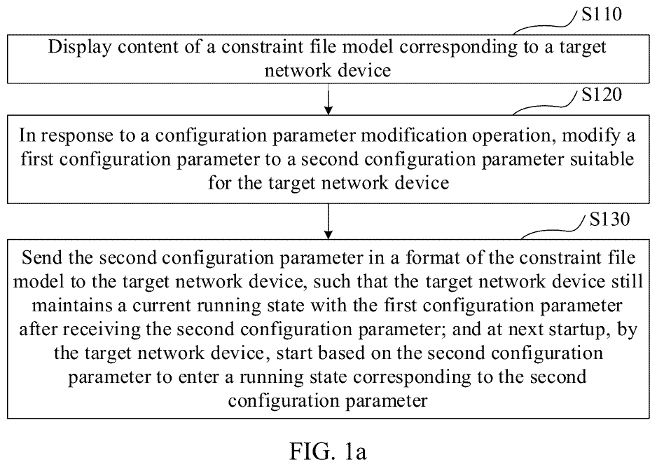

In the embodiments, a parameter configuration method is provided, which is applied to a configuration server. The configuration server is communicatively connected to a target network device. FIG. 1a is a flowchart of a parameter configuration method according to an embodiment of the present disclosure. As shown in FIG. 1a, the process of the parameter configuration method includes the following steps:
S110: Display content of a constraint file model corresponding to a target network device.

In some cases, in order to address limitations on a parameter configuration method in related technologies and enhance network flexibility, intelligence, and efficiency, a custom parameter configuration method can be adopted, which separates a data management plane from a data business plane in a cluster network.

Specifically, the cluster network may include a configuration server and the target network device (client). The configuration server may be a physical device of the data management plane. Through a CLI, the configuration server can be connected to a target network device enabled with a network management protocol, to obtain and operate configuration data of the target network device. The target network device may be any client device in the cluster network, such as a switch, a router, or a storage device. For example, FIG. 1b is a schematic diagram of device networking in the cluster network. Referring to FIG. 1b, the target network device (client) may be any one of a Spine device, a Leaf device, and a graphics processing unit (GPU) server device that supports network management protocols such as OpenFlow, Network Configuration Protocol (Netconf), Simple Network Management Protocol (SNMP), RESTCONF, gNMI, BGP-LS, and XMPP. The target network device can support mandatory Secure Shell (SSH) or Transport Layer Security (TLS) as a transport protocol.

Furthermore, applications (Apps) shown in FIG. 1b may be network control management Apps developed for business needs. A northbound interface may be an interface that connects to a core device in the cluster network. Specifically, through northbound abstraction, the Apps can obtain a global network view, simplifying development of management, control, and configuration services. The global network view can provide relevant network topology information for an application program, including a host, a switching and forwarding device, and a network-related state indicator. The application program is an intelligent management tool that can perform programming based on the global network view through an application programming interface (API). A southbound interface may be an interface that connects to the client device (such as a personal computer or a server) in the cluster network. Through the southbound interface, a core of the configuration server can be isolated from different devices (clients) and details of protocols.

For example, as shown in FIG. 1b, the southbound interface allows a system to utilize various network components such as the Spine device, the Leaf device, and a GPU server to create a unified network management view. Through southbound abstraction, the configuration server can unify diverse network elements in the cluster network into standardized objects. It can be understood that in this way, a distributed core system of the configuration server can maintain a state of a network element, and communication connection and configuration can be achieved without knowing details of each network element represented by an underlying driver program. Furthermore, the configuration server and its southbound abstraction can also allow various southbound protocols and client devices to use a plugin. The plugin can map and convert a general network element description and operation on the client device into a language that the client device can understand. In this way, when the client device uses a different protocol (such as the OpenFlow), the configuration server can also control or manage various types of client devices.

It can be understood that the northbound interface and the southbound interface of the configuration server provide an initial foundation for isolating the application program, a core layer, and an adapter from each other, that is, separate the data management plane from the data business plane. Through this modular separation design, the configuration server can be used as a software system, enabling a developer and a service provider to more easily carry out later-stage development for the software system as required. In addition, system stability can be maintained and upgraded through iterative parameter tuning. As the configuration server is built as a system composed of a plurality of independent components, and a direct dependency relationship between modules is implemented through southland and northbound interface modules, there also is a relatively small dependency between the modules. A dependency relationship between the modules can form an acyclic graph to avoid a complex dependency chain and make a system structure clearer. This facilitates expansion and upgrading in the future.

Based on this, a parameter configuration method applied to the configuration server communicatively connected to the target network device is implemented. Firstly, the content of the constraint file model corresponding to the target network device can be displayed. A constraint file may be a standardized document that defines a structure, a syntax, and a semantic meaning of a data model, as well as a hierarchical organization and a constraint of data. The constraint file can be understood as a standard-based scalable hierarchical data modeling language for modeling configuration and state data used for a network management protocol operation, a remote procedure call (RPC), and a server event notification. For example, the constraint file can be seen as a parameter configuration template, which not only clarifies a syntax structure of the data, but also describes a semantic meaning of the data in detail. Based on the content of the constraint file model, an association between the data and the constraint can be explicitly defined, allowing a user to quickly and directly customize configuration data that meets a constraint requirement and is grammatically correct.

Furthermore, the constraint file can not only exist as a complete independent unit, but also introduce definitions of other modules and sub-modules, allowing extension of an existing data model by adding an additional node. Specifically, although device configuration data is stored in a form of an extensible Markup Language (XML) document, a specific node and an allowed value in the document can be flexibly defined, and can be converted into a Yet Another Next Generation (YIN) format using an XML-based syntax. For example, Internet Engineering Task Force (IETF) can be used, which directly creates many models that can flexibly define a node, to further standardize and unify network management protocol interfaces for common network devices. It can be set that a system of a standard computer is described in a network interface configuration defined by an IETF-system model (RFC7317) or an IETF-interfaces model (RFC7223). For each system, some specific parameters are required in a network to ensure that a network protocol can work properly. These parameters need to be configured based on a specific network protocol requirement to ensure efficient and stable running of the network, in order to meet a data transmission requirement under large-scale networking.

It should be understood that due to use of the northbound interface and the southbound interface in an architecture of the cluster network, coupled with the constraint file, interaction between the client and the configuration server becomes more standardized through a standardized interface (the northbound interface and the southbound interface) and the data model (the constraint file), thereby separating the data management plane from the data business plane. Therefore, configuration data in the constraint file no longer needs to strictly focus on a parameter of the network itself. That is, in addition to the RPC defined by the network management protocol, the constraint file can also describe a feature of the configuration data, such as version information of a protocol session, device identifier information, a timestamp, a transport protocol or a security configuration, and whether to support SSH or TLS secure encryption.

Specifically, the content of the constraint file model includes a first configuration parameter corresponding to a current running state of the target network device.

The first configuration parameter may be a configuration parameter of the target network device in the current running state. Specifically, the first configuration parameter can define a running behavior of the target network device, such as a QoS setting, a port configuration, and traffic management, and can also reflect a configuration setting currently being used by the target network device.

It should be understood that model data of the cluster network may include state data and configuration data. The state data is inherent attribute data and currently-running dynamic information data of the client, and the like. This type of data only can be invoked for a query. The configuration data is static information data that defines a behavior and a running mode of a network device. Because the configuration data allows the user to customize a configuration as required, the configuration data itself has different representations. For example, the configuration data may include effective configuration data that corresponds to current state data and has been applied on the client, may include configuration data that is modified by a network administrator or the user, has not been applied to the client, and is to be submitted to take effect, and may also include configuration data for startup of an App of the client when the client starts in an initial configuration state.

Based on this, after a network control management App of the configuration server responds to a request from the network administrator or the user, the content of the constraint file model corresponding to the target network device is displayed. The content of the constraint file model includes the first configuration parameter of the target network device, and the first configuration parameter may be the configuration parameter of the target network device in the current running state, namely effective configuration data currently used by the target network device.
S120: In response to a configuration parameter modification operation, modify the first configuration parameter to a second configuration parameter suitable for the target network device.

The second configuration parameter may be a new configuration parameter obtained by the network administrator or the user by modifying the first configuration parameter based on a new business requirement or a network change, that is, the second configuration parameter is obtained. For example, the second configuration parameter can also include a QoS configuration, a port list configuration, and a traffic management configuration (traffic shaping, bandwidth allocation, and a bandwidth priority policy) of the target network device to optimize device performance, and adjust a new security policy and a traffic management rule. Specifically, the network administrator or the user can modify and adjust a configuration parameter of the target network device on the network control management App of the configuration server based on a network performance monitoring result or a business requirement change, to modify the first configuration parameter to the second configuration parameter suitable for the target network device.

It should be understood that in a process of modifying the first configuration parameter to the second configuration parameter, because the data management plane and the data business plane are separated through the northbound interface and the southbound interface, the target network device continues maintaining the current running state with the first configuration parameter, while the network administrator or the user modifies the first configuration parameter in a custom manner based on the new business requirement or the network change.
S130: Send the second configuration parameter in a format of the constraint file model to the target network device, such that the target network device still maintains the current running state with the first configuration parameter after receiving the second configuration parameter; and at next startup, by the target network device, start based on the second configuration parameter to enter a running state corresponding to the second configuration parameter.

It can be understood that since the second configuration parameter is generated by modifying the first configuration parameter in the custom manner, the configuration server also delivers the modified second configuration parameter to the corresponding target network device in the format of the constraint file model. That is, the second configuration parameter is also encapsulated in the constraint file model and stored in the form of the XML document.

Furthermore, since the data management plane and the data business plane are operationally separated, the target network device still maintains the current running state with the first configuration parameter after receiving the second configuration parameter. Until the next startup, the target network device overwrites the first configuration parameter by the second configuration parameter and starts based on the second configuration parameter to enter the running state corresponding to the second configuration parameter, which allows the network device to smoothly transition to a new configuration state without interrupting a service.

In the above implementations, the content of the constraint file model corresponding to the target network device is displayed, which allows the user to dynamically adjust a configuration parameter in the custom manner based on an actual running state and requirement of the network device, thereby providing the user with high flexibility to adapt to different network environments and business requirements. In addition, in the process of modifying the first configuration parameter to the second configuration parameter, it is ensured that the target network device can continue maintaining the current running state with the first configuration parameter. In this way, the network device does not need to interrupt the service in a configuration updating process, thereby ensuring continuity and real-time performance of the network. Thus, a real-time configuration method that can flexibly and dynamically adjust a parameter of the network device as required without interrupting the service is achieved.

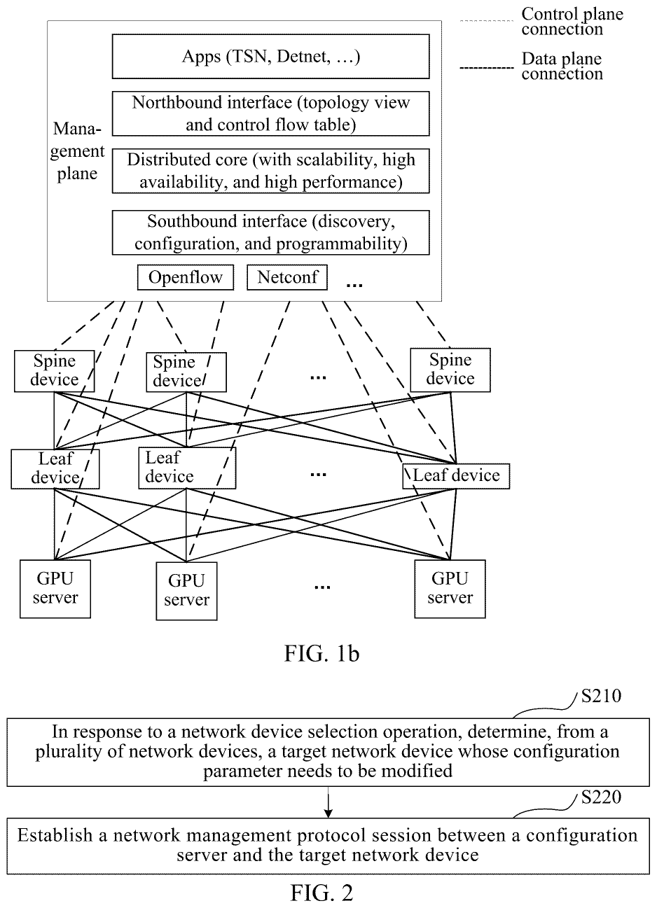

In some implementations, the configuration server is communicatively connected to a plurality of network devices, and before the displaying content of a constraint file model corresponding to the target network device, as shown in FIG. 2, the parameter configuration method further includes the following steps:
S210: In response to a network device selection operation, determine the target network device whose configuration parameter needs to be modified from the plurality of network devices.

The network device selection operation may be a process in which the network administrator or the user autonomously selects at least one specific device from the plurality of network devices for configuration management. The target network device may be a network device that is selected upon the network device selection operation and can accept a new configuration parameter. Specifically, the network administrator or the user can input an Internet Protocol (IP) address of the target network device on the network control management App of the configuration server to determine the target network device whose configuration parameter needs to be modified.
S220: Establish a network management protocol session between the configuration server and the target network device.

It can be understood that the network management protocol session may be a communication connection established between the configuration server and the target network device to transmit configuration data and a management command.

For example, the network management protocol session follows a specific network management protocol, such as the SNMP, the NETCONF, or the RESTCONF, to ensure accurate data transmission and correct device management. Specifically, a suitable network management protocol can be selected based on a network environment and device support, and necessary communication parameters can be set, for example, including an IP address, a port number, a community character string (for the SNMP) or a username and password (for the NETCONF or RESTCONF), and the like of a target device.

Furthermore, the configuration server sends an initialization request to the target network device to establish a session, thereby verifying identities and communication parameters of the configuration server and the target network device. Once authentication is successful, the target network device confirms the establishment of the session and is ready to receive the management command.

After establishing a link between the configuration server and the target network device through the network management protocol session, the target network device can reply to the configuration server with a message containing a feature and a capability that are supported by the target network device itself, mainly including version information of the network management protocol session, device identifier information, a timestamp, a transport protocol or a security configuration, whether to support the SSH or TLS secure encryption, and other information.

It can be understood that since the target network device (client) may be a network device that supports the mandatory SSH or the TLS as the transport protocol, that is, the network management protocol session may include a protocol using the SSH and the TLS as secure transport layers, the client can use either of these two transport protocols to establish a network management protocol session link upon successful connection, and send an RPC command of the network management protocol to the configuration server, such that the configuration server provides an accurate response based on the RPC command.

Optionally, the client can also implement most of key functions in an RFC 6241 standard, including validating a new configuration before applying the new configuration, to ensure security and compatibility of the new configuration. Alternatively, a previous configuration can be reverted when the new configuration fails to be applied, to ensure network stability. In addition, access control is also supported, which means that each user is granted access only to an assigned configuration for reading or writing and cannot access any other configurations. This ensures that each user can access or modify only an authorized configuration, thereby enhancing security and controllability of network management.

In the above implementations, the network administrator or the user can accurately select a specific network device for the configuration management, and conveniently call and display the content of the constraint file model corresponding to the target network device through the network control management App of the configuration server. This process not only simplifies the configuration management, but also ensures accuracy and real-time performance of a configuration.

In some implementations, the first configuration parameter is stored in a CIB of the target network device in the format of the constraint file model. The parameter configuration method further includes: sending a parameter locking instruction to the target network device.

The parameter locking instruction is configured to instruct the target network device to lock the CIB and continue maintaining the current running state with the first configuration parameter.

It can be understood that the CIB is a key component in a network management system, and configured to store various types of configuration data and state information of the network device.

Specifically, after the target network device whose configuration parameter needs to be modified is selected and the network management protocol session link between the configuration server and the target network device is established, in order to ensure that the first configuration parameter currently running on the target network device is not affected by an operation of another user or an administrator in a configuration modification process, the configuration server can send the parameter locking instruction to the target network device to instruct the target network device to lock its CIB and prevent another operation from changing the configuration.

In the above implementations, after the network management protocol session is established between the configuration server and the target network device, the parameter locking instruction is implemented to ensure that the target network device continues running with the first configuration parameter within a configuration modification period, while preventing intervention from the another user or the administrator. This avoids a potential configuration conflict and error, thereby ensuring accuracy and reliability of a configuration process.

In some implementations, the CIB includes a primary configuration database, a backup configuration database, and a startup configuration database.

The parameter locking instruction is configured to instruct the target network device to lock the primary configuration database or simultaneously lock the primary configuration database, the backup configuration database, and the startup configuration database.

Specifically, in a network management process, the configuration server communicates with the target network device through the network management protocol session, and sends the parameter locking instruction to the target network device to lock the primary configuration database or simultaneously lock the primary configuration database, the backup configuration database, and the startup configuration database, to prevent the another operation from changing the configuration during configuration changing and ensure the accuracy of the configuration process.

The primary configuration database can be configured to store the configuration parameter corresponding to the current running state of the target network device, that is, to store the effective configuration data that corresponds to the current state data and has been applied on the client. The backup configuration database can be configured to store backup data of the configuration parameter, that is, to store the configuration data that is modified by the network administrator or the user, has not been applied to the client, and is to be submitted to take effect. It should be understood that configuration parameters stored in the backup configuration database and the primary configuration database are consistent, that is, the primary configuration database and the backup configuration database can be mutually redundant configurations. The startup configuration database can be configured to store a recovery configuration parameter used by the target network device after restarting. The recovery configuration parameter is data that can ensure normal running of the client device during device initialization and startup.

Specifically, when the user wants to modify the configuration parameter of the target network device, the user can invoke the first configuration parameter that is currently running on the target network device and stored in the primary configuration database of the client on the network control management App of the configuration server, and modify the first configuration parameter. In this process, the first configuration parameter is also backed up in the backup configuration database in real time. In this case, if the primary configuration database fails and cannot be used, data stored in the backup configuration database in real time can be used to continue running. Furthermore, if the backup configuration database also fails and cannot be used, an initial recovery configuration parameter can be invoked from the startup configuration database to ensure that the target network device does not fail to run due to damage of the primary configuration database and the backup configuration database.

For example, a port configuration parameter is used as an example for description. A port 1 is used for initialization and startup of a network device. Therefore, port configuration parameters stored in a primary configuration database, a backup configuration database, and a startup configuration database of the network device are all the port 1. Furthermore, if the user changes the port 1 to a port 2, port configuration parameters stored in both the primary configuration database and the backup configuration database are the port 2, while a port configuration parameter stored in the startup configuration database is still the port 1. If the primary configuration database of the network device suddenly cannot be opened at this time, a configuration parameter with the port configuration parameter being the port 2 can be obtained from the backup configuration database to continue running. If both the primary configuration database and the backup configuration database of the network device are damaged and cannot be opened at a next time point, only a configuration parameter with the port configuration parameter being the port 1 can be obtained from the startup configuration database for running, and the configuration parameter is modified again, such that the port 1 is changed to the port 2 to meet a new requirement.

In the above implementations, a locking mechanism is used to prevent the another operation or the user from changing the configuration during the configuration changing, thereby maintaining stable running of the network device when modifying the configuration parameter. In addition, the three databases are designed, and both an old configuration parameter before the modification and a new configuration parameter after the modification are backed up. Furthermore, if a problem occurs on the new configuration parameter, the old configuration parameter can be quickly rolled back, thereby ensuring stability and reliability of the network.

In some implementations, after the target network device modifies the first configuration parameter to the second configuration parameter, the parameter configuration method further includes: sending a parameter unlocking instruction to the target network device.

The parameter unlocking instruction is configured to release a locked state of the CIB.

Specifically, after the target network device successfully modifies the first configuration parameter to the second configuration parameter, the configuration server sends the parameter unlocking instruction to the target network device. The parameter unlocking instruction is configured to inform the target network device that the configuration modification process has been completed and locked states of the primary configuration database, the backup configuration database, and the startup configuration database can be released.

Furthermore, after receiving the parameter unlocking instruction, the target network device correspondingly releases the locked state of the CIB, and restores the CIB to a normal state, allowing another user or the administrator to perform a data business operation or make a possible configuration change again subsequently.

In the above implementations, the sending of the parameter unlocking instruction indicates smooth completion of the configuration modification process, thereby allowing the network device to release the locked state of the CIB, resuming normal running, and providing a possibility for a subsequent configuration change. The parameter unlocking instruction is sent after the target network device successfully modifies the first configuration parameter to the second configuration parameter, which not only ensures integrity of the configuration changing and the stability of the network, but also improves flexibility and security of network configuration management.

In some implementations, the parameter configuration method further includes: if the second configuration parameter in the format of the constraint file model passes compliance verification of the target network device, receiving a confirmation response sent by the target network device.

It can be understood that after the configuration parameter is modified, a modified configuration parameter may not necessarily be correctly applied to the target network device. For example, the port configuration parameter is still used as an example for description. The port 1 is used for initialization and startup of a network device. During the modification, the port 1 is changed to a port 10, but the network device may not have the port 10. Therefore, the modification is illegal and cannot be correctly applied to the target network device.

Therefore, after the first configuration parameter is modified to the second configuration parameter, the configuration server delivers a compliance verification command to the target network device, such that the target network device performs the compliance verification on the second configuration parameter.

The compliance verification may be an operation process in which a series of legality checks are performed on the new configuration parameter before the new configuration parameter is applied, to verify whether the new configuration parameter complies with hardware and software requirements of the network device, a network policy, a security standard, and any related Service Level Agreement (SLA). Specifically, the compliance verification may include basic syntax validation, structure and rule checking, entity and character reference validation, data type and range constraint checking of an element, and the like.

Specifically, during the modification, the configuration server sends the second configuration parameter in the format of the constraint file model to the target network device. After receiving the second configuration parameter, the target network device can use its verification module to parse the second configuration parameter and perform the compliance verification on the new configuration parameter according to a predefined rule and standard to ensure legality, compatibility, and reliability of a configuration parameter setting. If the second configuration parameter passes the compliance verification, the target network device sends the confirmation response to the configuration server, indicating that the new configuration parameter has been accepted and is ready for application. If the second configuration parameter cannot pass the compliance verification of the target network device, the target network device does not send an acknowledgement (ACK) response frame, indicating that the modification to the second configuration parameter is illegal and invalid.

In the above implementations, the compliance verification also ensures legality, compatibility, and reliability of a network device configuration parameter. In addition, it is ensured that only a configuration parameter that meets the hardware and software requirements of the network device, the network policy, the security standard, and the SLA can be applied, thereby significantly improving security and effectiveness of the network management.

In some implementations, the first configuration parameter is stored in the primary configuration database of the target network device in the format of the constraint file model. After receiving the confirmation response, the parameter configuration method further includes: sending a parameter modification instruction to the target network device, such that the target network device modifies the first configuration parameter in the primary configuration database to the second configuration parameter, and in a process of modifying the first configuration parameter by the target network device, the target network device still maintains the current running state with the first configuration parameter.

Specifically, after receiving the confirmation response based on the compliance verification from the target network device, the configuration server sends the parameter modification instruction to the target network device to instruct the target network device to modify a current configuration parameter (the first configuration parameter) in the primary configuration database to a new configuration parameter (the second configuration parameter). After receiving the parameter modification instruction, the target network device starts an updating process in its primary configuration database, thereby replacing the first configuration parameter with the second configuration parameter. For example, the second configuration parameter can be directly used to overwrite the first configuration parameter, which is also stored in the primary configuration database in the format of the constraint file model and synchronized to the backup configuration database.

Optionally, as the primary configuration database and the backup configuration database are the mutually redundant configurations, the backup configuration database can also support repeated custom parameter configuration processes. After confirming that the second configuration parameter has passed the compliance verification, a parameter configuration of the backup configuration database can also be used to overwrite the primary configuration database to achieve data backup.

It should be noted that in this process, since the data management plane and the data business plane are operationally separated, in the process of modifying the first configuration parameter in the primary configuration database to the second configuration parameter by the target network device, the running state of the target network device is free from interference and still maintains the current running state with the first configuration parameter. For example, after the target network device modifies the first configuration parameter in the primary configuration database to the second configuration parameter, a data updating request can be displayed in a front-end pop-up window of the target network device. If the user confirms to perform an update, the target network device restarts in response to a confirmation request and runs with the second configuration parameter as a configuration parameter. If the user does not confirm to perform the update, the second configuration parameter can be temporarily stored in a configuration database, without forcibly interrupting a current running process to update the configuration parameter. Instead, next time, the target network device starts and runs directly with the second configuration parameter as the configuration parameter.

In the above implementations, after confirming that the second configuration parameter has passed the compliance verification and receiving the confirmation response, the configuration server instructs the target network device to update a parameter in the primary configuration database to a new configuration, while ensuring that the target network device continues running with the first configuration parameter to prevent the service from being uninterrupted. After the user confirms the update, the target network device restarts and the new configuration parameter is applied, thereby ensuring stability of the network device and flexibility of parameter updating.

In some implementations, the first configuration parameter is at least one of a QoS configuration parameter, a port list configuration parameter, and a traffic management configuration parameter.

The QoS configuration parameter may be a configuration parameter that defines QoS for data transmission in the network, and is used to ensure that a critical App of the target network device can obtain a necessary bandwidth and a low latency to ensure its application performance. Specifically, the QoS configuration parameter may include data packet classification, priority allocation, queue management, and the like to achieve differentiated processing of network traffic.

The port list configuration parameter may be a configuration parameter that involves a configuration of each port on the network device, including port enabling, port disabling, rate limitation, and the like, and is configured to allow the network administrator to define which ports can be used for the data transmission and transmission characteristics about how these ports perform transmission.

The traffic management configuration parameter may be a configuration parameter for controlling and optimizing the network traffic, including monitoring, analyzing, and regulating the network traffic to prevent network congestion and meet the SLA, thereby effectively utilizing a network resource and maximizing network performance.

Furthermore, the traffic management configuration parameter includes at least one of traffic shaping, bandwidth allocation, and a bandwidth priority policy.

The traffic shaping may be a traffic management technique used to control a transmission rate of the network traffic and prevent given traffic from occupying an excessive bandwidth to affect other traffic. The bandwidth allocation may be a traffic management technique that allocates a total bandwidth of the network to different users, Apps, or services. The bandwidth priority policy may be a traffic management technique that defines priorities of different types of traffic, and can be used to set a priority of traffic based on a type, a source, or a destination of the traffic, ensuring that critical business traffic can be preferentially processed in the network.

In the above implementations, the QoS configuration parameter, the port list configuration parameter, and the traffic management configuration parameter are comprehensively used, which allows the user to customize the configuration parameter based on business and transmission needs, thereby achieving fine management and optimal allocation of the network resource, ensuring performance of a critical App, and further improving overall QoS of the network. In addition, these parameters can be modified in real time without interrupting a business of the target network device, which not only maximizes utilization of the network resource, but also significantly improves the stability and the reliability of the network, thereby providing an efficient, stable, and responsive running environment for the target network device.

The implementations of the present disclosure also provide a parameter configuration method, which is applied to a configuration server. The configuration server is communicatively connected to a plurality of network devices. A first configuration parameter is stored in a CIB of a target network device in a format of a constraint file model. The first configuration parameter is at least one of a QoS configuration parameter, a port list configuration parameter, and a traffic management configuration parameter. The traffic management configuration parameter includes at least one of traffic shaping, bandwidth allocation, and a bandwidth priority policy. The CIB includes a primary configuration database, a backup configuration database, and a startup configuration database. The parameter configuration method includes the following steps:
S302: In response to a network device selection operation, determine the target network device whose configuration parameter needs to be modified from the plurality of network devices.
S304: Establish a network management protocol session between the configuration server and the target network device.
S306: Send a parameter locking instruction to the target network device.

The parameter locking instruction is configured to instruct the target network device to lock the primary configuration database or simultaneously lock the primary configuration database, the backup configuration database, and the startup configuration database, and to continue maintaining a current running state with the first configuration parameter. The primary configuration database is configured to store a configuration parameter corresponding to the current running state of the target network device; the backup configuration database is configured to store backup data of the configuration parameter corresponding to the current running state of the target network device; and the startup configuration database is configured to store a recovery configuration parameter used by the target network device after restarting.
S308: Display content of a constraint file model corresponding to the target network device.

The content of the constraint file model includes the first configuration parameter corresponding to the current running state of the target network device.
S310: In response to a configuration parameter modification operation, modify the first configuration parameter to a second configuration parameter suitable for the target network device.

In a process of modifying the first configuration parameter to the second configuration parameter, the target network device continues maintaining the current running state with the first configuration parameter.
S312: Send the second configuration parameter in the format of the constraint file model to the target network device, such that the target network device performs compliance verification on the second configuration parameter.
S314: If the second configuration parameter in the format of the constraint file model passes the compliance verification of the target network device, receive a confirmation response sent by the target network device.
S316: After receiving the confirmation response, send a parameter modification instruction to the target network device, such that the target network device modifies the first configuration parameter in the primary configuration database to the second configuration parameter, and in a process of modifying the first configuration parameter by the target network device, the target network device still maintains the current running state with the first configuration parameter.
S318: After the target network device modifies the first configuration parameter to the second configuration parameter, send a parameter unlocking instruction to the target network device.

The parameter unlocking instruction is configured to release a locked state of the CIB.
S320: After modifying the first configuration parameter to the second configuration parameter, the target network device still maintains the current running state with the first configuration parameter, and at next startup, the target network device starts based on the second configuration parameter to enter a running state corresponding to the second configuration parameter.

It should be understood that although the steps in the above flowcharts are shown in sequence as indicated by the arrows, these steps are not necessarily performed in sequence as indicated by the arrows. An execution order of these steps is not strictly limited, and these steps may be executed in other orders, unless clearly described otherwise. Moreover, at least some of the steps in the above flowcharts may include a plurality of steps or stages. The steps or stages are unnecessarily executed at a same time point, but may be executed at different time points. An execution order of the steps or stages is unnecessarily carried out sequentially, but may be executed alternately or in turn with other steps or at least one of the steps or stages of other steps.

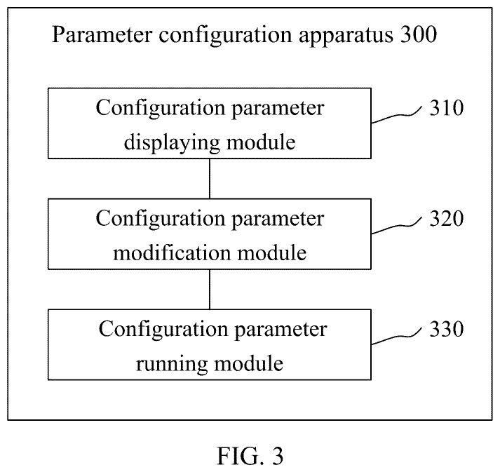

The implementations of the present disclosure also provide a parameter configuration apparatus 300, which is applied to a configuration server. The configuration server is communicatively connected to a target network device. As shown in FIG. 3, the parameter configuration apparatus 300 includes a configuration parameter displaying module 310, a configuration parameter modification module 320, and a configuration parameter running module 330.

The configuration parameter displaying module 310 is configured to display content of a constraint file model corresponding to the target network device, where the content of the constraint file model includes a first configuration parameter corresponding to a current running state of the target network device.

The configuration parameter modification module 320 is configured to: in response to a configuration parameter modification operation, modify the first configuration parameter to a second configuration parameter suitable for the target network device, where in a process of modifying the first configuration parameter to the second configuration parameter, the target network device continues maintaining the current running state with the first configuration parameter.

The configuration parameter running module 330 is configured to send the second configuration parameter in a format of the constraint file model to the target network device, such that the target network device still maintains the current running state with the first configuration parameter after receiving the second configuration parameter; and at next startup, by the target network device, start based on the second configuration parameter to enter a running state corresponding to the second configuration parameter.

In some implementations, the configuration server is communicatively connected to a plurality of network devices, and before displaying the content of the constraint file model corresponding to the target network device, the parameter configuration apparatus 300 further includes a network management protocol session establishment module configured to: in response to a network device selection operation, determine the target network device whose configuration parameter needs to be modified from the plurality of network devices; and establish a network management protocol session between the configuration server and the target network device.

In some implementations, the first configuration parameter is stored in a CIB of the target network device in the format of the constraint file model. The parameter configuration apparatus 300 further includes a parameter locking module configured to send a parameter locking instruction to the target network device, where the parameter locking instruction is configured to instruct the target network device to lock the CIB and continue maintaining the current running state with the first configuration parameter.

In some implementations, the parameter configuration apparatus 300 further includes a CIB module configured to include a primary configuration database, a backup configuration database, and a startup configuration database. The parameter locking instruction is configured to instruct the target network device to lock the primary configuration database or simultaneously lock the primary configuration database, the backup configuration database, and the startup configuration database. The primary configuration database is configured to store a configuration parameter corresponding to the current running state of the target network device; the backup configuration database is configured to store backup data of the configuration parameter corresponding to the current running state of the target network device; and the startup configuration database is configured to store a recovery configuration parameter used by the target network device after restarting.

In some implementations, after the target network device modifies the first configuration parameter to the second configuration parameter, the parameter locking module is further configured to send a parameter unlocking instruction to the target network device. The parameter unlocking instruction is configured to release a locked state of the CIB.

In some implementations, the parameter configuration apparatus 300 further includes a response confirmation module configured to: if the second configuration parameter in the format of the constraint file model passes compliance verification of the target network device, receive a confirmation response sent by the target network device.

In some implementations, the first configuration parameter is stored in the primary configuration database of the target network device in the format of the constraint file model, and after receiving the confirmation response, the configuration parameter running module 330 is further configured to send a parameter modification instruction to the target network device, such that the target network device modifies the first configuration parameter in the primary configuration database to the second configuration parameter, and in a process of modifying the first configuration parameter by the target network device, the target network device still maintains the current running state with the first configuration parameter.

In some implementations, the configuration parameter modification module 320 is further configured to determine the first configuration parameter as at least one of a QoS configuration parameter, a port list configuration parameter, and a traffic management configuration parameter. The traffic management configuration parameter includes at least one of traffic shaping, bandwidth allocation, and a bandwidth priority policy.

For specific limitations on the parameter configuration apparatus, reference may be made to the above limitations on the parameter configuration method. Details are not described herein again. The modules of the parameter configuration apparatus may be implemented in whole or in part by software, hardware, or any combination thereof. The modules may be embedded in or independent of a processor of a computer device in a form of hardware, or stored in a memory of the computer device in a form of software, such that the processor can easily invoke and execute corresponding operations of the modules.

The parameter configuration apparatus in the embodiments is presented in a form of functional units, where the units are Application Specific Integrated Circuit (ASIC) circuits, processors and memories that execute at least one piece of software or fixed program, and/or other devices that can provide the above functions.

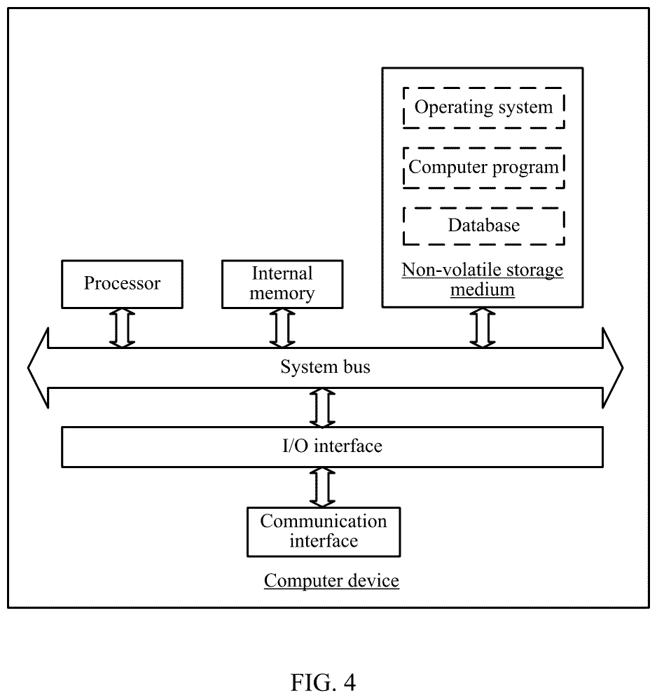

The embodiments of the present disclosure further provide a computer device. The computer device may be a terminal, and an internal structure thereof may be shown in FIG. 4. The computer device includes a processor, a memory, a communications interface, a display, and an input apparatus that are connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for running the operating system and the computer program in the non-volatile storage medium. The communications interface of the computer device is configured for wired or wireless communication with an external terminal. The wireless communication can be achieved through wireless fidelity (WiFi), a cellular mobile network, near-field communication (NFC), or other means. When the computer program is executed by the processor, a parameter configuration method is implemented. The display of the computer device may be a liquid crystal display (LCD) or an e-ink display. The input apparatus of the computer device may be a touch layer covering the display, may be a key, a trackball, or a touchpad set on a housing of the computer device, may be an external keyboard, touchpad or mouse, or the like.

Those skilled in the art may understand that the structure shown in FIG. 4 is only a block diagram of a part of the structure related to the solutions of the present disclosure and does not constitute a limitation on a computer device to which the solutions of the present disclosure are applied. Specifically, the computer device may include more or less components than those shown in the figure, or combine some components, or have different component arrangements.

The embodiments of the present disclosure also provide a computer-readable storage medium, and the method according to the embodiments of the present disclosure may be implemented in hardware or firmware, or may be implemented as computer code that can be recorded on a storage medium, or as computer code that is originally stored on a remote storage medium or a non-transitory machine-readable storage medium, is downloaded through a network, and is to be stored on a local storage medium. Therefore, the method described herein can be processed by such software stored on a storage medium using a general-purpose computer, a dedicated processor, or programmable or dedicated hardware. The storage medium may be a magnetic disk, an optical disk, a read-only memory (ROM), a random access memory (RAM), a flash memory, a hard disk drive (HDD), a solid-state drive (SSD), or the like. The storage medium may alternatively be a combination of the foregoing types of memories. It can be understood that a computer, a processor, a microprocessor controller, or programmable hardware includes a storage component that can store or receive software or computer code. When the software or the computer code is accessed and executed by the computer, the processor, or the hardware, the method shown in the above embodiments is implemented.

The embodiments of the present disclosure further provide a computer program product. The computer program product includes a computer instruction. The computer instruction is stored in a computer-readable storage medium. A processor of a computer device reads the computer instruction from the computer-readable storage medium, and the processor executes the computer instruction to enable the computer device to perform the method in any one of the embodiments of the present disclosure.

The parameter configuration method, the parameter configuration apparatus, and the computer device described in the foregoing embodiments may be specifically implemented by a computer chip or entity, or implemented by product with a specific function. One typical implementation device is the computer. Specifically, the computer may be, for example, a personal computer, a laptop computer, a cellular phone, a camera phone, a smartphone, a personal digital assistant, a media player, a navigation device, an E-mail device, a game console, a tablet computer, a wearable device, or a combination thereof.

For ease of description, the foregoing apparatus is divided into various units based on functions for separate description. Certainly, functions of the units may be implemented in one or more pieces of software and/or hardware during implementation of the present disclosure.

Those skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may be in a form of a computer program product that is implemented on at least one computer-usable storage medium (including but not limited to a magnetic disk memory, a compact disc read-only memory (CD-ROM), an optical memory, and the like) that includes computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, such that the instructions executed by the computer or the processor of the another programmable data processing device generate an apparatus for implementing a specific function in one or more processes in the flowcharts and/or in one or more blocks in the block diagrams.

These computer program instructions may alternatively be stored in a computer-readable memory that can instruct a computer or another programmable data processing device to work in a specific manner, such that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, such that a series of operations and steps are performed on the computer or the another programmable device to generate computer-implemented processing. Therefore, the instructions executed on the computer or the another programmable device provide steps for implementing a specific function in one or more processes in the flowcharts and/or in one or more blocks in the block diagrams.

In the description of this specification, the description with reference to the terms such as “one embodiment”, “some embodiments”, “an example”, “a specific example”, or “some examples” means that specific features, structures, materials, or characteristics described with reference to the embodiment or example are included in at least one embodiment or example of the present disclosure. In this specification, the schematic descriptions of the above terms do not necessarily refer to the same embodiment or example. Moreover, the specific features, structures, materials, or characteristics described may be combined in any suitable manner in any one or more embodiments or examples.

In addition, the terms “first” and “second” are merely intended for a purpose of description, and shall not be understood as indicating or implying relative importance or implying a quantity of indicated technical features. Therefore, a feature limited by “first” or “second” may explicitly or implicitly include at least one such feature. In the description of the present disclosure, “a plurality of” means at least two, such as two or three, unless otherwise clearly and specifically limited.

It should also be noted that the term “comprise/include”, “contain”, or any other variant thereof is intended to encompass a non-exclusive inclusion, such that a process, method, product, or device that includes a series of elements includes not only those elements, but also other elements not explicitly listed, or also includes elements that are inherent to such a process, method, product, or device. Without more restrictions, an element defined by the phrase “including a . . . ” does not exclude the presence of another same element in a process, method, product, or device that includes the element.

The embodiments in this specification are described in a progressive manner. For same or similar parts between embodiments, reference may be made to each other. Each embodiment focuses on a difference from other embodiments. For an apparatus embodiment, since it is basically similar to the method embodiment, the description is relatively simple, and reference can be made to the description of the method embodiment.

The above are merely embodiments of the present disclosure, and are not intended to limit the present disclosure. Various changes and modifications can be made to the present disclosure by those skilled in the art. Any modifications, equivalent replacements, improvements, and the like made within the spirit and principle of the present disclosure should fall within the scope defined by the claims of the present disclosure.

Although the embodiments of the present disclosure are described with reference to the accompanying drawings, those skilled in the art may make various modifications and variations without departing from the spirit and scope of the present disclosure. These modifications and variations shall fall within the scope defined by the claims.

It can be understood that before using the technical solutions in the embodiments of the present disclosure, a user is informed of a type, a usage scope, and a usage scenario of involved personal information in an appropriate manner according to relevant laws and regulations, and authorization is obtained from the user.

For example, in response to receiving an active request from the user, a prompt message is sent to the user to clearly prompt the user that personal information of the user needs to be obtained and used for a requested operation. Therefore, based on the prompt message, the user can autonomously choose whether to provide the personal information to software or hardware such as an electronic device, an application program, a server, or a storage medium that performs operations of the technical solutions in the present disclosure.

As an optional but non-limiting implementation, in response to receiving the active request from the user, for example, the prompt message may be sent to the user by means of a pop-up window. The prompt message can be presented in a text format in the pop-up window. In addition, the pop-up window can also carry a selection control for the user to choose whether to “agree” or “disagree” to provide the personal information to the electronic device.

It can be understood that the above user authorization notification and obtaining process is only illustrative and does not limit the implementations in the present disclosure. Other methods that comply with relevant laws and regulations can also be applied to the implementations in the present disclosure.

It can be understood that data involved in the technical solutions (including but not limited to the data itself, data acquisition or use) should comply with corresponding laws and regulations, and relevant provisions.

It should be noted that in the specific implementations of the present disclosure, when the above embodiments of the present disclosure are applied to specific products or technologies, a user's permission or consent is required for relevant data involving user information, position information, navigation data, and the like, and the collection, use, and processing of the relevant data need to comply with relevant laws, regulations, and standards of related countries and regions.

1. A parameter configuration method, applied to a configuration server, wherein the configuration server is communicatively connected to a target network device, and the parameter configuration method comprises:
displaying content of a constraint file model corresponding to the target network device, wherein the content of the constraint file model comprises a first configuration parameter corresponding to a current running state of the target network device;
in response to a configuration parameter modification operation, modifying the first configuration parameter to a second configuration parameter suitable for the target network device, wherein in a process of modifying the first configuration parameter to the second configuration parameter, the target network device continues maintaining the current running state with the first configuration parameter; and
sending the second configuration parameter in a format of the constraint file model to the target network device, whereby the target network device still maintains the current running state with the first configuration parameter after receiving the second configuration parameter; and at next startup, by the target network device, starting based on the second configuration parameter to enter a running state corresponding to the second configuration parameter.

2. The parameter configuration method according to claim 1, wherein the configuration server is communicatively connected to a plurality of network devices, and before the displaying content of a-the constraint file model corresponding to the target network device, the parameter configuration method further comprises:
in response to a network device selection operation, determining the target network device whose configuration parameter needs to be modified from the plurality of network devices; and
establishing a network management protocol session between the configuration server and the target network device.

3. The parameter configuration method according to claim 1, wherein the first configuration parameter is stored in a configuration information base (CIB) of the target network device in the format of the constraint file model, the parameter configuration method further comprises:
sending a parameter locking instruction to the target network device, wherein the parameter locking instruction is configured to instruct the target network device to lock the CIB and continue maintaining the current running state with the first configuration parameter.

4. The parameter configuration method according to claim 3, wherein the CIB comprises a primary configuration database, a backup configuration database, and a startup configuration database, and the parameter locking instruction is configured to instruct the target network device to lock the primary configuration database or simultaneously lock the primary configuration database, the backup configuration database, and the startup configuration database;
the primary configuration database is configured to store a configuration parameter corresponding to the current running state of the target network device;
the backup configuration database is configured to store backup data of the configuration parameter corresponding to the current running state of the target network device; and
the startup configuration database is configured to store a recovery configuration parameter used by the target network device after restarting.

5. The parameter configuration method according to claim 3, wherein
after the target network device modifies the first configuration parameter to the second configuration parameter, the parameter configuration method further comprises:
sending a parameter unlocking instruction to the target network device, wherein the parameter unlocking instruction is configured to release a locked state of the CIB.

6. The parameter configuration method according to claim 1, wherein the parameter configuration method further comprises:
after the second configuration parameter in the format of the constraint file model passes compliance verification of the target network device, receiving a confirmation response sent by the target network device.

7. The parameter configuration method according to claim 6, wherein the first configuration parameter is stored in a primary configuration database of the target network device in the format of the constraint file model, and after receiving the confirmation response, the parameter configuration method further comprises:
sending a parameter modification instruction to the target network device, whereby the target network device modifies the first configuration parameter in the primary configuration database to the second configuration parameter, and in a process of modifying the first configuration parameter by the target network device, the target network device still maintains the current running state with the first configuration parameter.

8. The parameter configuration method according to claim 1, wherein the first configuration parameter comprises one or more of a quality of service (QOS) configuration parameter, a port list configuration parameter, and a traffic management configuration parameter; and
the traffic management configuration parameter comprises one or more of traffic shaping, bandwidth allocation, and a bandwidth priority policy.

9. A parameter configuration apparatus, applied to a configuration server, wherein the configuration server is communicatively connected to a target network device, and the parameter configuration apparatus comprises:
a configuration parameter displaying module configured to display content of a constraint file model corresponding to the target network device, wherein the content of the constraint file model comprises a first configuration parameter corresponding to a current running state of the target network device;
a configuration parameter modification module configured to: in response to a configuration parameter modification operation, modify the first configuration parameter to a second configuration parameter suitable for the target network device, wherein in a process of modifying the first configuration parameter to the second configuration parameter, the target network device continues maintaining the current running state with the first configuration parameter; and
a configuration parameter running module configured to send the second configuration parameter in a format of the constraint file model to the target network device, whereby the target network device still maintains the current running state with the first configuration parameter after receiving the second configuration parameter; and at next startup, by the target network device, start based on the second configuration parameter to enter a running state corresponding to the second configuration parameter.

10. A computer device, comprising:
a memory and a processor, wherein the memory and the processor are communicatively connected to each other; the memory stores a computer instruction, and the processor executes the computer instruction to perform the parameter configuration method according to claim 1.

11. The parameter configuration method according to claim 2, wherein the first configuration parameter comprises one or more of a quality of service (QOS) configuration parameter, a port list configuration parameter, and a traffic management configuration parameter; and
the traffic management configuration parameter comprises one or more of traffic shaping, bandwidth allocation, and a bandwidth priority policy.

12. The parameter configuration method according to claim 3, wherein the first configuration parameter comprises one or more of a quality of service (QOS) configuration parameter, a port list configuration parameter, and a traffic management configuration parameter; and
the traffic management configuration parameter comprises one or more of traffic shaping, bandwidth allocation, and a bandwidth priority policy.

13. The parameter configuration method according to claim 4, wherein the first configuration parameter comprises one or more of a quality of service (QOS) configuration parameter, a port list configuration parameter, and a traffic management configuration parameter; and
the traffic management configuration parameter comprises one or more of traffic shaping, bandwidth allocation, and a bandwidth priority policy.

14. The parameter configuration method according to claim 5, wherein the first configuration parameter comprises one or more of a quality of service (QOS) configuration parameter, a port list configuration parameter, and a traffic management configuration parameter; and
the traffic management configuration parameter comprises one or more of traffic shaping, bandwidth allocation, and a bandwidth priority policy.

15. The parameter configuration method according to claim 6, wherein the first configuration parameter comprises one or more of a quality of service (QOS) configuration parameter, a port list configuration parameter, and a traffic management configuration parameter; and
the traffic management configuration parameter comprises one or more of traffic shaping, bandwidth allocation, and a bandwidth priority policy.

16. The parameter configuration method according to claim 7, wherein the first configuration parameter comprises one or more of a quality of service (QOS) configuration parameter, a port list configuration parameter, and a traffic management configuration parameter; and
the traffic management configuration parameter comprises one or more of traffic shaping, bandwidth allocation, and a bandwidth priority policy.
